(19) United States
(12) Patent Application Publication
(10) Pub. No.: US 2009/0012191 A1
(43) Pub. Date: Jan. 8, 2009

(54) LIGHTWEIGHT WALL STRUCTURE MATERIAL AND PROCESS FOR MAKING

(76) Inventor: Scott Deans, Altamonte Springs, FL (US)

Correspondence Address: James H. Beusse, Esquire;Beusse Wolter Sanks Mora & Maire, P.A., Suite 2500, 390 North Orange Avenue, Orlando, FL, 32801, US

(21) Appl. No.: 12/166,494

(22) Filed: Jul. 2, 2008

Related U.S. Application Data
(60) Provisional application No. 60/947,866, filed on Jul. 3, 2007.

(51) Int. Cl. C04B 7/02

(52) U.S. Cl. 521/54; 521/154

(57) ABSTRACT

This invention relates to a method for creating a lightweight cementatious material for use in building construction. The material can be formed in panels to replace conventional drywall gypsum board. In the disclosed form the product does not include any paper or other components that serve as food for mold and therefore is mold resistant. The material has a composition of Portland cement, foamed glass beads and an acrylic co-polymer. In some forms, sand may be used as a filler and in others, the filler may be polystyrofoam particles and vermiculite.

### SPECIFIC DATA RELATED TO THE INVENTION

This application claims the benefit of U.S. Provisional Application No. 60/947,866 filed Jul. 3, 2007.

The present invention relates to building construction and, more particularly, to a material for producing prefabricated building wall sections for use in replacing concrete block.

### BACKGROUND OF THE INVENTION

Typical building construction uses concrete blocks that are individually set in mortar to construct walls of a building. These blocks are nominally 8×8×16 inches when measured with the associated mortar joints. Each block weighs about 40 pounds and the laying of the blocks to create a wall is a labor intensive task. Various methods have been proposed to overcome the labor issues involved in laying block, including creating forms and pouring solid concrete walls. Other proposals have used prefabricated wall panels such as foam core panels that can be put in place and then sprayed with a concrete surface. It has also been proposed to prefabricate a foam core panel with outer concrete surfacing that can be lifted in place using lifting apparatus at the job site. However, recent changes in building codes have required that building walls have sufficient solid concrete segments to withstand hurricanes and tornados.

One of the issues with the prior art wall structures has been the material from which walls are formed. While lightweight concrete material is known in the art, commercially available material often does not have sufficient strength to resist high winds and the debris that is often carried by the winds. In addition, it is desirable to provide a material that has a high resistance to heat so as to maximize fire retarding. Still further, the material should be of a type that can be used for interior walls, including bathroom walls, and have no food value so as to resist mold growth.

### SUMMARY OF THE INVENTION

The present invention is directed to a unique combination of elements that create a lightweight concrete mixture that can be used to construct exterior walls that have fire and mold retarding ability. In a preferred form, the mixture is used to create lightweight wall structures of the type described in U.S. patent application Ser. No. 11/466,694, the disclosure of which is hereby incorporated by reference.

In one form, the present invention uses a combination of adhesive additives and foamed glass beads (Poraver glass granules) in a Portland cement mix to create a lightweight concrete mix having high structural strength and fire resistance. The additives, such as Forton Polymer, increase the bonding of the beads to the cement/sand mix.

In another form, the present invention further reduces the weight of the mixture by adding ground/recycled polystyrofoam pellets to the mixture. In a further form, further weight reduction may be achieved by replacing sand in the concrete mix with vermiculite. In still another form, the invention includes addition of glass fiber to the mix in order to increase compressive and tensile strength.

### DETAILED DESCRIPTION OF THE PREFERRED EMBODIMENTS

The lightweight concrete material of the present invention is produced by mixing in a conventional concrete mixer the various combinations as set forth in the following examples. For purposes of ease of explanation, the quantities are set forth in conventional construction terminology based on a typical bag of Portland Cement that weighs U.S. 94 pounds. Further, since the quantities of other components added to the mix are normally measured out in a standard five-gallon bucket that is filled to the brim so that it holds approximately six gallons, the volumes of other materials are set forth in either bucket volume or by weight or both. It is known that a 94 pound bag of cement is one cubic foot and that a conventional 5-gallon bucket filled to the brim is about 0.8 cubic foot.

### Example 1

Table 1 below sets forth a preferred embodiment of the mixture for producing the wall panels described in the aforementioned application Ser. No. 11/466,694. This mix is a basic sand mixture and is heavier than a mix using polystyrofoam or vermiculite; however, it does have high strength and fire resistance from the sand and foamed glass beads.

Wall Panel Mixture

| | |
|---|---|
| Water | 1½ buckets by volume |
| Forton Polymer | 1 gal. by volume |
| Portland Cement | 94 lbs. |
| Sand | 65 lbs. (about 1 bucket) |
| 1-2 mm Poraver ® Beads | 25 lbs. (about 2½ buckets) |
| 2-4 mm Poraver ® Beads | 25 lbs. (about 2½ buckets) |
| Fiber | 4 lbs. (about ⅜ bucket) |

While the preferred mixture as set forth in Example 1 has been found to produce a drywall panel having the desired characteristics, it may be desirable to add a wetting agent or plastizer to the mixture. For that purpose, it has been found that 4 ounces of ADVA 140 plastisizer is sufficient to work with this volume mixture. If setting time is an issue, one may also add a hardener such as Rapid Hardener from Ultimax Cement Corp in the amount of about 3-5 pounds for this volume mix, depending on desired setting time. In addition, the amount of Forton Polymer can be varied, generally up to about 2 gallons, to provide increased bonding and strengthening of the mix with the understanding that the cure time increases with the higher concentration since the polymer slows curing of the mix. If the mix of Example 1 is used for stucco, one would reduce the water to about 1 bucket to get a thicker consistency.

Variations of the above mixture may also be used, such as in the volumes set forth in Examples 2 and 3 below. Example 2 is a conventional sand mix while Example 3 is a Vermiculite Mix. As discussed above, the sand mix has greater strength but also is much heavier due to the weight of the sand and the increased volume of water required for the mix.

### Example 2

Stucco Mixture

| | |
|---|---|
| Water | 1 bucket |
| Forton Polymer | 1 gal. |
| Portland | 94 lbs. |
| Sand | 1 bucket (dry, <10% moisture) |
| 1-2 MM Poraver ® Beads | 3 buckets. |
| 2-4 mm Poraver ® Beads | 3 buckets |
| Fiber | ⅜ bucket. |

### Example 3

Vermiculite Mixture

| | |
|---|---|
| Water | 1½ buckets |
| Forton Polymer | 1 gallon. |
| Portland Cement | 94 lbs. |
| Vermiculite | 2 buckets. |
| 1-2 mm Poraver ® Beads | 1 buckets |
| 2-4 mm Poraver ® Beads | 1 buckets |
| Fiber | ⅜ bucket |

In each of the Tables above, the Forton polymer is available from Ball Consultants, Inc. under the mark FORTON and identified as an acrylic co-polymer under the designation VF 774. Poraver Beads are foam glass granules available from DENNERT PORAVER GMBH. The fiber is available from Ball Construction as an Anticrak HP 18 mm glass fiber mesh. Vermiculite is available from many sources but a preferred form is available as a Grade 4 from Grace Construction Products. As with Example 1, all of the Examples can be modified by addition of 4 ounces of ADVA 140 plastisizer and a hardener such as Rapid Hardener from Ultimax Cement Corp.

The following Example 4 is for a lighter weight product that incorporates polystyrofoam obtained from recycled foam products while Example 5 is a still lighter product that replaces all of the sand with vermiculite. The mix of Example 5 actually absorbs water after curing and can be used around the lowest area of a slab construction building to draw moisture out of the building at the slab edges.

### Example 4

Foam Mix

| | |
|---|---|
| Water | 1½ buckets |
| Forton Polymer | 1 gallon |
| Portland Cement | 94 lbs |
| Sand | 1 bucket |
| 1-2 mm Poraver ® Beads | ¾ bucket |
| 2-4 mm Poraver ® Beads | ¾ bucket |
| Foam | 4 buckets |
| Fiber | ⅜ bucket |

### Example 5

Vermiculite Mix

| | |
|---|---|
| Water | 1½ buckets |
| Forton Polymer | ¼ gallon |
| Portland | 94 lbs |
| Vermiculite | 4 buckets |
| Fiber | ⅜ bucket |

In each of the above examples, the quantities were selected to represent the minimum volume of components to mix with a standard bag of Portland Cement for a given application. Accordingly, it will be recognized that variations in the quantities may be made in order to enhance certain attributes of the resulting product. For example, The volume of water will change the mix characteristics to be thicker or thinner. A thick mix could be used like stucco for application as a layer over an existing wall. Adding more water will make the mix thinner such that it can be poured into a mold to create a pre-formed panel that can be used to replace conventional drywall. The

Applicant has also found that the Forton Polymer should be mixed with the water during adding of these components. If the polymer is added at a later time, it tends to create clumps and does not mix thoroughly in a conventional concrete mixer. The volume of the polymer should be adjusted to the minimum required for the application because of the cost of the polymer. However, too much polymer will substantially delay curing. Too little polymer in a mix will reduce the bonding strength. In Example 2, the combination of sand and polymer resulted in a product having about a 1400 psi strength. In Example 3, replacing the sand with vermiculite resulting in a product having only 600 psi strength. The latter product is useful in those applications where a lightweight panel is required but the panel is not load bearing.

The volume of Poraver glass beads used in the Examples can also be varied depending on the particular application. However, it should be noted that equal volumes of the two different sizes of beads are preferred to obtain maximum panel strength. A higher volume of beads delays cure time of a panel made from the exemplar mixes. Higher bead volume will also make a panel more brittle and fail at a lower psi. An increase in volume of beads will also necessitate a decrease in the volume of sand although it has been found that sand cannot be totally eliminated (although it can be totally replaced by vermiculite) from the mix if a resulting product is to have any level of strength. Applicant has increased the volume of beads 10 fold and still produced a usable panel but with significantly decreased strength.

The volume of fiberglass fibers in each mix is selected to provide a product that meets strength requirements for construction use while not having fiber ends protruding onto a surface of a panel. Applicant has found that about ⅜ of a bucket of Fiber is the maximum that can be used without the fibers defacing the surface of a drywall panel. It should be noted that the fibers can be eliminated if the mix is being used over lath or a mesh product that will function as the binding element of the mix.

Styrofoam pellets can be used in higher concentration than the amounts listed in the examples with the understanding that a panel product made from the mix will be weaker and flexible. If used as a drywall panel, such flex will make the product harder to work with. The function of the stryrofoam is to remove weight from panels made from the mix and applicant has found that while 6-8 buckets of Styrofoam will still work in producing a panel, the resulting panel, while lightweight, is weak, flexible and may be uneven. Further, adding more foam also increases cure time since the foam tends to absorb water in the mix.

The polystyrofoam mix can be used to create a foam board for insulation that overcomes some of the problems of foam insulation boards currently used in construction. In particular, the present foam boards tend to produce toxic fumes during combustion. The boards or panels can be formed by pouring the mix of any of the examples into a flat mold with defined side edges and letting the mix cure until hardened. Applicant has found that the mix of Example 6 can be used to create a lightweight cement based foam panel in which the foam particles are encapsulated in cement. Testing has shown that these panels have significantly reduced fume emission when the panels are subjected to fire. It is believed that the foam material in the panels melts rather than being burned and that much of the fume that is produced is absorbed into the cementations material. In addition, the melting of the foam produces air pockets within the panel that serves to maintain much of its insulation properties during a fire.

### Example 6

| | |
|---|---|
| Water | 1½ buckets |
| Forton Polymer | 1 gallon |
| Portland Cement | 94 lbs |
| Sand | ¼ bucket |
| Foam | 7 buckets |
| Fiber | ⅜ bucket |

While Example 6 includes some glass fiber for strengthening the panel, it has been found that the loose fiber can be eliminated and a fiberglass cloth mesh incorporated into the panel by placing the mesh into the form before pouring the cementatious mixture into the form. Further, since the panel of this Example is merely intended to be used as insulation board and does not require any structural strength, it is believed that all fiber could be eliminated from the product.

I claim:

1. A method for producing a lightweight concrete composition comprising:
mixing Portland cement and sand to form a dry cementations composition;
combining water and an acrylic co-polymer into the dry composition to form a mix having a desired consistency;
adding at least two different sizes of foamed glass beads into the mix as a filler; and
adding loose glass fibers into the mix.

2. The method of claim 1 and including replacing at least some of the sand with vermiculite.

3. The method of claim 1 and including replacing all of the sand with vermiculite.

4. The method of claim 1 wherein the foamed glass beads comprise equal volumes of 1-2 mm and 2-4 mm beads.

5. The method of claim 1 and including adding polystyrofoam particles into the mix.

6. The method of claim 1 and including replacing the glass beads with polystyrofoam particles.

7. The method of claim 6 and including pouring of the mix into a flat mold to form a cement panel.

8. The method of claim 6 wherein the ratio of foam to cement is about 5.6:1 by volume.

9. The method of claim 8 wherein the sand in the mix is about 1.5 gallon by volume.

10. The method of claim 9 wherein the foam replaces all of the fiber.
